(19) United States
(12) Patent Application Publication
(10) Pub. No.: US 2003/0041966 A1
(43) Pub. Date: Mar. 6, 2003

(54) Method of joining laminates for z-axis interconnection

(75) Inventors: Jon A. Casey, Poughkeepsie, NY (US); Brian E. Curcio, Binghamton, NY (US); John U. Knickerbocker, Hopewell Junction, NY (US); Voya R. Markovich, Endwell, NY (US); Mark D. Poliks, Vestal, NY (US)

Correspondence Address: DRIGGS, LUCAS, BRUBAKER & HOGG CO. L. P. A., DEPT IFI, 8522 EAST AVENUE, MENTOR, OH, 44060, US

(73) Assignee: International Business Machines Corporation, Armonk, NY

(21) Appl. No.: 09/944,284

(22) Filed: Aug. 31, 2001

(51) Int. Cl. C09J 5/10; B05D 5/12

(52) U.S. Cl. 156/306.6; 427/97

(57) ABSTRACT

A method of forming a laminated composite printed wiring structure of a plurality of at least three superimposed subcomposites having organic substrates is provided. Via openings in the subcomposite structures having conductive paste therein are positioned to align with openings in at least one adjacent subcomposite structure also filled with conductive paste that is to be joined thereto. Printed wiring is provided on at least one face of one subcomposite structure. A fixture with pins which extends through index openings in the composites are provided to mount masks for screening paste and stacking of the composites is provided. After screening of paste, and partially curing of the paste, in each composite, a group of composites is placed on the fixture and the pastes are fully cured to form a unitary structure.

### FIELD OF THE INVENTION

This invention relates generally to forming multi-level, organic printed wiring boards and, more particularly, to a method of joining subcomposite structures utilizing electrically conductive paste for z-axis interconnects to form printed wiring boards, such as chip carriers.

### BACKGROUND OF THE INVENTION

Organic based printed wiring boards are conventionally made up of a plurality of individual elements or subcomposite structures joined together to provide various levels of wiring and power planes on the surfaces of the elements or subcomposites and interconnections between the various wiring levels, such interconnections between the various wiring and power plane levels often being referred to as z-axis interconnections. In some conventional techniques for forming such interconnections in the z-axis, a drilling operation is required after the various elements have been joined together. This requires precise alignment of all the elements as well as precise drilling of the final structure which creates the possibility of misalignment, at least requiring either rework of the board or, at most, scrapping of the board after it reaches this late assembly stage. There have been various prior art proposals for forming the z-axis interconnect to eliminate the drilling of the final structure. However, in some instances, it is difficult to precisely align the z-axis interconnects of the subcomposite structures in certain types of very dense circuitry type chip carriers. Thus, it is desirable to provide a technique for forming z-axis interconnects of subcomposites forming a printed circuit board or printed wiring board which provides accurate alignment of the z-axis interconnects as well as reliable connections of the z-axis interconnects at the various interfaces which allow processing of parts according to similar processing techniques in other technologies

### SUMMARY OF THE INVENTION

According to the present invention, a method of forming a laminated composite printed wiring structure of a plurality of at least three superimposed subcomposites is provided. The method includes providing a plurality of organic, dielectric subcomposite structures, each having opposed faces and a plurality of through via openings therein extending between the faces. The via openings in the subcomposite structures are positioned to align with openings in at least one adjacent subcomposite structure that is to be joined thereto. Printed wiring is provided on at least one face of one subcomposite structure and at least one power plane is also provided in at least one subcomposite structure. Each via opening is filled with a conductive paste material that can be subsequently hardened and cured with the conductive paste material extending beyond at least one face of one subcomposite structure. A plurality of aligned index openings are provided in each subcomposite structure which will cooperate with fixture pins to align the filled via holes of the various subcomposite substructures where required when in superimposed relationship. The index openings also cooperate with pins to align the subcomposites for filling through screens, stencils, or masks. The via holes in the subcomposites are filled with the subcomposites, each being held in a fixture with a mask also being held in the fixture. An adhesive is provided between adjacent subcomposite structures, the adhesive having openings for the conductive paste. Conductive paste is less than the fully cured so that the paste in adjacent layers can bond together when fully cured. The subcomposite structures are laid up with the adhesive material disposed there between in superposed relationship on a fixture including elements extending through said index openings to align the subcomposite structure with the conductive paste and adjacent openings in said subcomposite structures in contact with each other. The conductive paste is then cured fully and the laminate wiring structure is formed from the superimposed subcomposite structures. In one embodiment, the subcomposite structures are fully circuitized before being laid up and formed into a composite laminate, using conventional circuitizing techniques and, in another embodiment, conductive paste is utilized on at least some faces of the subcomposite structures to provide the circuitization prior to being laid up in a laminate structure.

### DESCRIPTION OF THE DRAWINGS

FIG. 1 is a side elevational view, partly in section and somewhat schematic, showing one subcomposite element for use in forming a printed wiring structure according to one embodiment of the present invention;

FIG. 2 is a view similar to FIG. 1 of another subcomposite element for use in forming the printed wiling structure according to said one embodiment of the present invention;

FIG. 3 is a plan view of a card showing several subcomposite elements being formed on a single card and which elements can be cut from the cards to form the individual elements;

FIG. 4 is a perspective view, somewhat diagrammatic, showing a fixture and mask for filling a subcomposite element with conductive paste;

FIG. 5 is a view similar to FIG. 1 showing the vias filled with a conductive paste;

FIG. 6 is a view similar to FIG. 2 showing the vias filled with a conductive paste;

FIG. 7 is a somewhat schematic view of a series of elements comprised of subcomposite elements shown in FIGS. 5 and 6 being laid up in a fixture to form a composite laminate printed wiring board;

FIG. 8 is a view similar to FIG. 1 of one element of a subcomposite structure for use in forming a laminated wiring board according to another embodiment of the present invention;

FIG. 9 is a view similar to FIG. 2 of subcomposite structure for use in forming a laminated printed wiring board according to the other embodiment of this invention;

FIG. 10 is a view of the subcomposite structure of FIG. 8 having the vias filled with conductive paste and circuit lines screened thereon;

FIG. 11 is the subcomposite structure of FIG. 9 having the vias filled with conductive paste and the outer layers of copper foil etched therefrom;

FIG. 12 shows subcomposite structures of FIGS. 10 and 11 laid up for lamination to form a laminated printed wiring structure; and

FIG. 13 is a view similar to FIG. 12 but utilizing the subcomposite structures of FIGS. 10 and 11 laid up for lamination to a composite wiring structure utilizing separate adhesive materials between said subcomposite structures.

### DESCRIPTION OF THE PREFERRED EMBODIMENTS

The present invention provides two separate embodiments of a technique for forming a composite wiring structure utilizing conductive paste to form z-axis interconnections of the various subcomposite structures forming the laminated printed wiring structure. In one embodiment, which is described herein as the first embodiment, relatively conventional techniques are utilized to circuitize the various organic subcomposite structures which are utilized to form the laminated printed wiring structure; and then the printed wiring structure is formed by laminating these subcomposites together utilizing conductive paste in the plated through holes of each of the subcomposite structures to provide the z-axis via interconnects between adjacent subcomposite structures.

In another embodiment, hereinafter referred to as the second embodiment, organic subcomposites are provided which have circuitry formed thereon by conductive paste techniques, as well as utilizing conductive paste to form Z-axis interconnect vias through openings in adjacent subcomposite structures.

First Embodiment

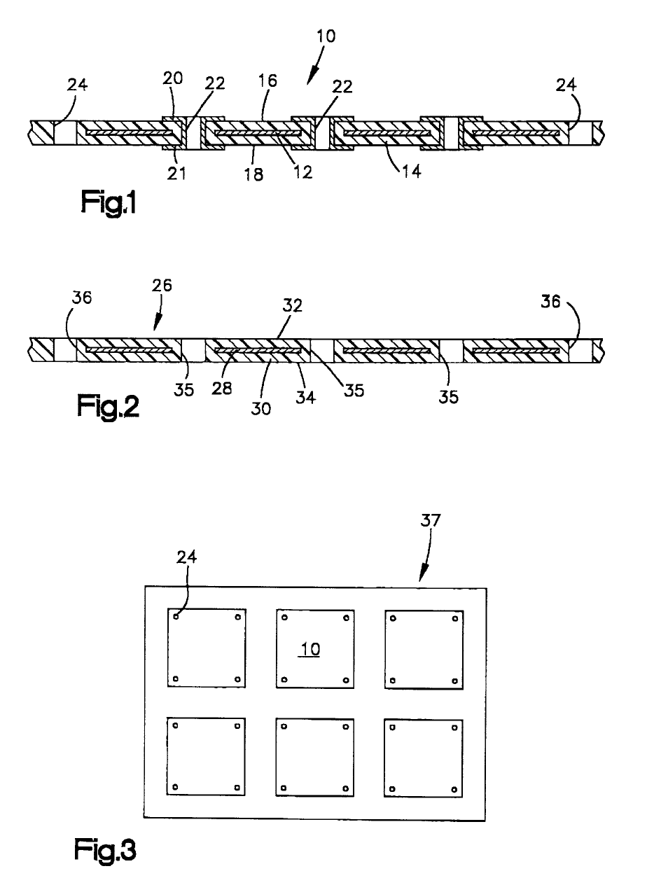

For the first embodiment of the present invention, two different subcomposite elements are shown in FIGS. 1 and 2. In FIG. 1, a 2S1P subcomposite element is shown, and in FIG. 2, a 0S1P subcomposite element is shown (according to convention, 2S1P refers to two signal planes and one power plane, and the 0S1P refers to no signal plane and one power plane).

As seen in FIG. 1, the 2S1P subcomposite designated by the reference character 10 is provided with a power plane 12 surrounded by an organic dielectric material 14. The dielectric material can be any conventional organic material that is cured for making printed wiring structures. Particularly useful are silica filled polytetrafluoroethylene (PTFE); fiberglass or aromatic polyamid (or aramid) fiber or expanded PTFE reinforced epoxy, cyanate ester, BT (bismaleimide triazine) prepreg or laminate, example FR-4; or combination of hydrocarbon based thermosets and thermoplastics such as Rogers RO4350 by the Rogers Corporation; or suitable organic based, inorganic or inorganic filled or reinforced composite laminate material. The subcomposite 10 has opposite sides 16 and 18, with signal circuitry 20 and 21 formed on sides 16 and 18, respectively, of the subcomposite structure 10. The subcomposite structure 10 also includes a plurality of plated through holes 22. Subcomposite 10 is formed with a plurality of registration openings 24, the location and purpose of which will be described presently.

The 0S1P subcomposite designated by the reference character 26 includes a power plane 28 surrounded by dielectric material 30, such as a filled PTFE or FR-4, or polyamids or Rogers R04350 by Rogers Corp., a hydrocarbon having thermoset or thermoplastic, or other suitable organic material, having opposite sides 32 and 34. A plurality of through holes 35 are formed therethrough. The subcomposite 26 has a plurality of registration openings 36, again the purpose and location of which will be described presently. The subcomposite structures 10 and 26 are preferably produced using traditional printed wiring board technology which does not need to be described in detail. Generally, this technology involves the steps of laminating, drilling, hole cleaning, plating and circuitization. Also, in the case of each subcomposite 10, 26, this is preferably done in a large card 37, as shown in FIG. 3, from which the subcomposites can be cut. The cards 37 to form subcomposites illustrated in FIG. 3 are for subcomposite structure 10. However, the subcomposites 26 can be formed in the same way. As can be seen, the registration openings 24 are located at the four comers of each of the subcomposite structures 10. The same is true for the registration openings 36 in subcomposite 26.

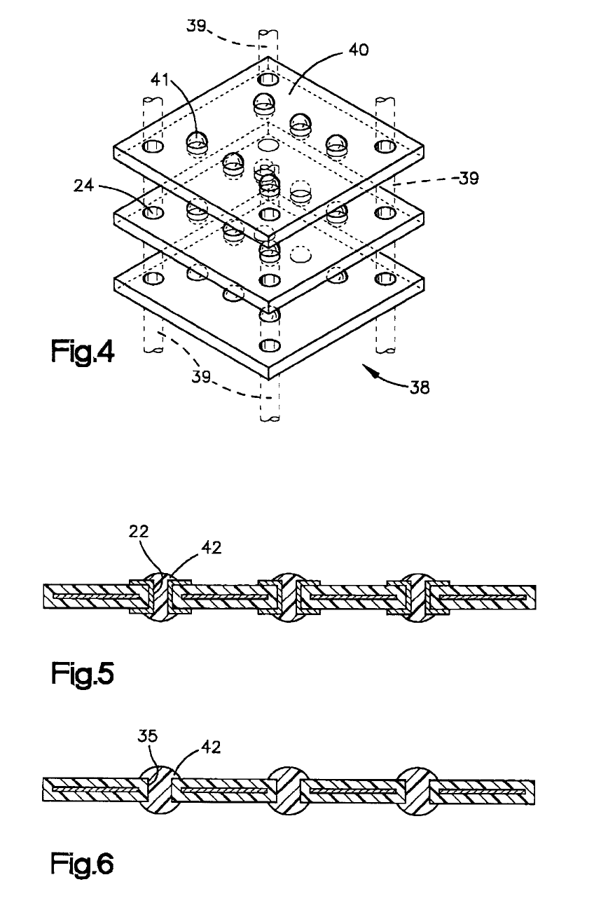

Once the circuitized subcomposite structures 10 and 26 have been fully formed and cut from the card 37, the plated through openings 22 are filled with an electrically conductive paste, which is done in the following manner. A paste filling fixture 38 is provided which has a plurality of upwardly extending rods or other similar locating devices 39 located to engage the registration openings, either 24 or 36, in the subcomposite structures 10 and 26. The subcomposite structures 10 and 26 are individually placed on the fixtures 38 with the rods 39 extending through either the openings 24 or 36 depending upon which subcomposite structure is to be filled. A mask 40, having registration holes (unnumbered) and openings 41 therein, is provided with the mask placed on the rods 39 over a subcomposite 10 or 24 so that the openings 41 therein align with each of the openings 24 or 35, whichever subcomposite is being filled. Conductive paste 42 (FIGS. 5 and 6) is then applied over the mask 41 by squeegees, or injection techniques or other suitable means so that it will go through the openings 41 and into the openings 22 or 35 in either the subcomposite structure 10 or 26. The conductive paste is applied in a flowable form so that it can flow through the openings 41 and into the openings 22 or 35 and thereafter be either dried or cured (hereinafter collectively referred to as cured) in steps that will be described presently. Particularly useful pastes which can be used are Ablestik 8175 manufactured by the Ablestik Corporation or CB100 manufactured by E. I. du Pont de Nemours and Company. These are conductive epoxies which can be cured to various states of curing and are applied in the uncured state. It is to be understood, however, that other types of conductive paste can be used and these are merely illustrative.

FIGS. 5 and 6 show the subcomposite structures 10 and 26, respectively, with openings 22 and 35 filled with conductive adhesive 42 such as Ag, Sn/Pb or Sn/Bi coated or mixed with Cu particles in an organic thermosetting resin such as an epoxy. At this stage, the conductive adhesive 42 is either left uncured or only partially cured (e.g. B-stage cured in the case of epoxies) so that when the subcomposite structures are superposed and joined (as will be described presently), the paste 42 in the openings in adjacent subcomposites 10, 24 will join together to form a coherent. cohesive and electrically conductive bond or union.

Referring now to FIG. 7, a somewhat diagrammatic showing of the lay up of alternating 2S1P and 0S1P subcomposites is shown to form a composite wiring board. (It should be noted that one of the subcomposites is designated as 10′. This is a slightly modified form of subcomposite 10, formed according to the teachings of patent application Ser. No. 09/871,555, filed May 31, 2001, entitled “METHOD FOR FILING HIGH ASPECT RATIO VIA HOLES IN ELECTRONIC SUBSTRATES AND THE RESULTING HOLES”, Attorney Docket No. END920000119US1 (IEN-10-5560). The various subcomposite structures 10 (or 10′) and 26 are placed alternately over alignment pins 52, with dielectric adhesive sheets 44 interposed between each pair of adjacent subcomposite structures 10 (or 10′) and 26, with the dielectric adhesive sheets 44 having openings 46 therein, each aligned with adjacent conductive paste fillers 42 in the subcomposite structures 10 (or10′) and 26, as shown in FIG. 7. Also, optionally, copper coated dielectric materials 48 can be placed on opposite sides of the entire composite structure. These copper coated dielectric sheets 48 eventually can be patterned and formed to electrical circuitry in a conventional manner. Particularly useful are silica filled polytetrafluoroethylene (PTFE); fiberglass or aromatic polyamid (or aramid) fiber or expanded PTFE reinforced epoxy, cyanate ester, BT (bismaleimide triazine) prepreg or laminate, example FR-4; or combination of hydrocarbon based thermosets and thermoplastics such as Rogers RO4350 by the Rogers Corporation; or suitable organic based, inorganic or inorganic filled or reinforced composite laminate material. Heat and pressure are then applied to the stacks of subcomposite structures 10 (or 10′) and 26, preferably the heat being at about 185° C. for about 90 minutes (for epoxies), which will cause the adjacent subcomposite structures 10 (or 10′) and 26 to bond together due to the action of the adhesive sheets 44, and the interface of the adjacent, electrically conductive paste 42 will bond together and the entire electric column of the joined conductive paste 42 in all of the subcomposites will be fully or C-cured (in the case of epoxies) forming a fully conductive z-axis connection between adjacent subcomposite structures.

It is to be understood that the illustration of the two particular subcomposite structures 10 and 26 is merely illustrative and various different subcomposite structures can be utilized to form different types of composite printed wiring structures.

Referring now to FIGS. 8-13, another embodiment of the present invention is shown; this is referred to as the second embodiment.

Second Embodiment

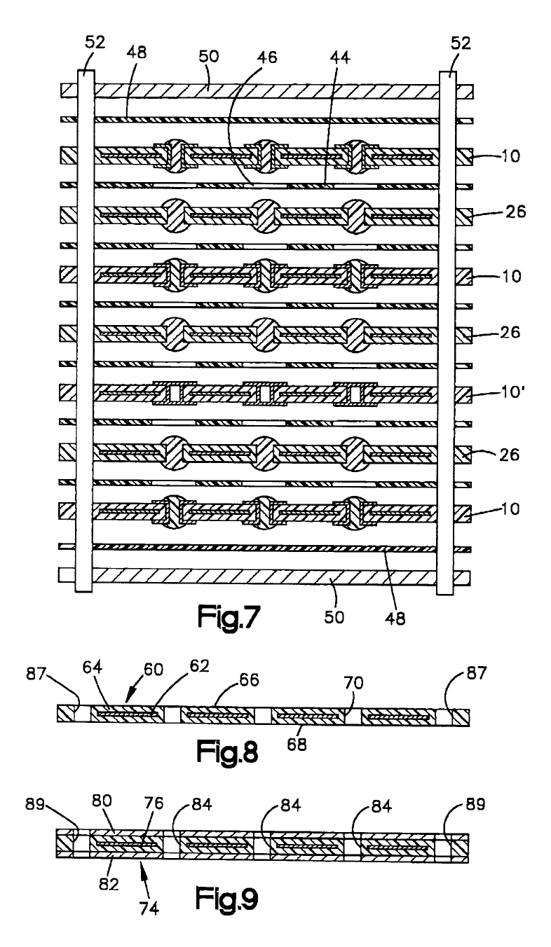

Referring now to FIGS. 8 and 9, again subcomposite structures, which will eventually be formed into a composite wiring structure, are shown. The subcomposite of FIG. 8, will eventually be formed into a 1S1P subcomposite and of FIG. 9 will be formed into a 0S1P subcomposite. Referring now to FIG. 8, a subcomposite structure 60 is shown having a copper core 62 and an organic dielectric material 64 surrounding the core 62. Again, the dielectric materials that may be particularly useful are silica filled polytetrafluoroethylene (PTFE); fiberglass or aromatic polyamid (or aramid) fiber or expanded PTFE reinforced epoxy, cyanate ester, BT (bismaleimide triazine) prepreg or laminate, example FR-4; or combination of hydrocarbon based thermosets and the rmoplastics such as Rogers RO4350 by the Rogers Corporation; or suitable organic based, inorganic or inorganic filled or reinforced composite laminate material. The subcomposite has opposite faces 66 and 68, with openings 70 extending therethrough. This subcomposite will eventually be circuitized, as will be described presently, to form a 1S1P subcomposite, although it is to be understood that a 2S1P plane could also be formed.

In FIG. 9, a subcomposite structure 74 is shown, which has a copper core 76, organic dielectric material 78, such as silica filled polytetrafluoroethylene (PTFE); fiberglass or aromatic polyamid (or aramid) fiber or expanded PTFE reinforced epoxy, cyanate ester, BT (bismaleimide triazine) prepreg or laminate, example FR-4; or combination of hydrocarbon based thermosets and thermoplastics such as Rogers RO4350 by the Rogers Corporation; or suitable organic based, inorganic or inorganic filled or reinforced composite laminate material surrounding the copper core 76, and copper foil 80 and 82 on opposite sides of the dielectric material. Openings 84 extend through the entire subcomposite structure 74.

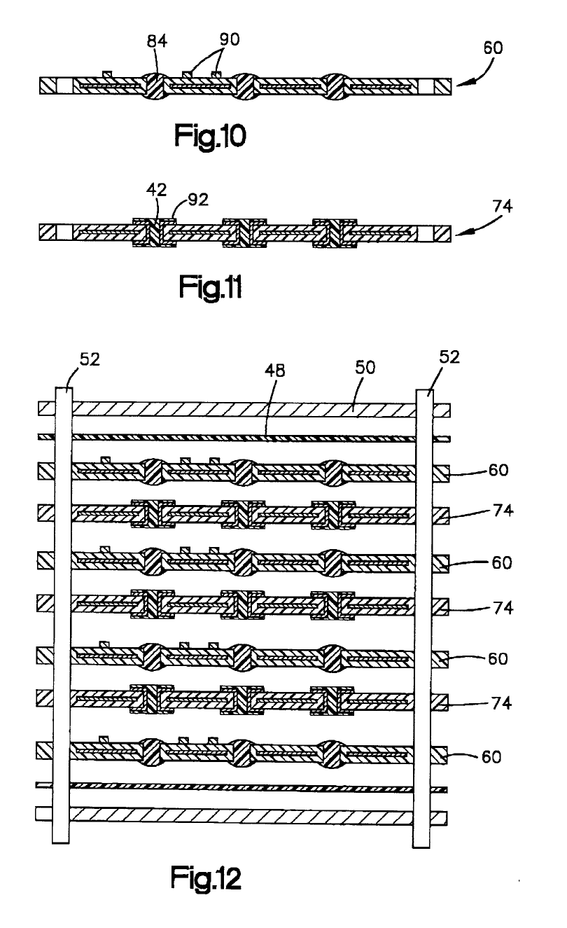

As in the previous embodiment, the subcomposite 60 has registration opening 87 therein and the subcomposite 74 has registration openings 89 therein. The subcomposites are preferably made in multiples on a card as in the previous embodiment, and are cut from the card. In this embodiment, as in the previous embodiment, each of the subcomposite structures 60 and 74 is placed on the fixture 38 with the pins 39 extending through the registration openings 87 or 89 and the mask 40 put in place. However, in this case, the mask 40 has openings, not only for providing conductive paste 42 in the openings 70 and 84, but also additional openings to allow the conductive paste 42 to be applied to the face 66 of the subcomposite 60 to form the signal traces 90 as shown in FIG. 10. Thus, in this case, the circuitization of the subcomposite 60 takes place by the use of conductive paste rather than by conventional and traditional circuitization techniques. Also entire power and ground planes can be applied by printing through masks or the like.

In this embodiment, copper foil 80 and 82 on the opposite sides of the subcomposite 74 are etched away to leave the conductive paste 42 having exposed protrusions 92 on both sides thereof. The pastes are then B-cured (if epoxies).

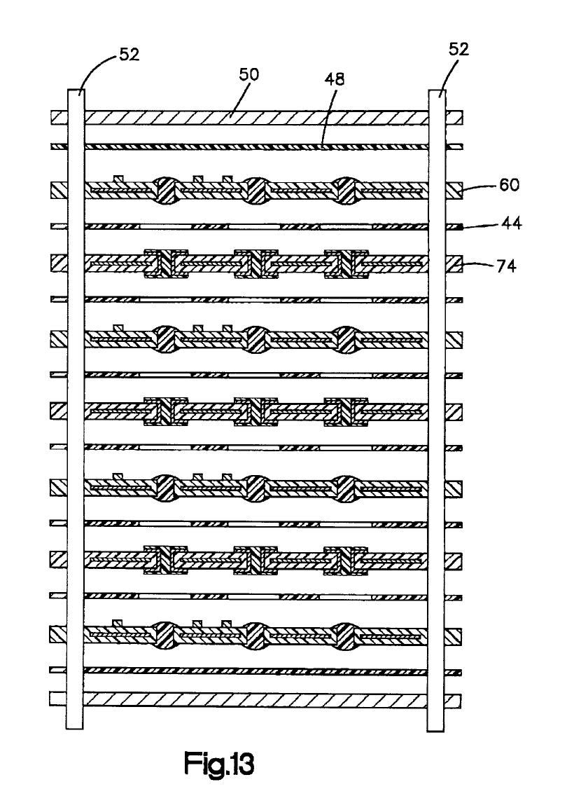

At this point, the subcomposites 60 and 74 are stacked alternately on the pins 52 of the fixture in contact with each other as shown in FIG. 12, and the entire stack structure put under pressure and heated to about 185° C. for about 90 minutes to C cure the adhesive, and laminate the stack and to C-cure the conductive paste forming circuitry 90 to form continues electrically conducting paths.

FIG. 13 shows a variation of the second embodiment wherein separate dielectric sheets 46 are used between adjacent subcomposites 60 and 74, just as in the previous embodiment.

Accordingly, the preferred embodiments have been described. With the foregoing description in mind, however, it is understood that this description is made only by way of example, that the invention is not limited to the particular embodiments described herein, and that various rearrangements, modifications, and substitutions may be implemented without departing from the true spirit of the invention as hereinafter claimed.

What is claimed is:

1. A method of forming a laminated composite printed wiring structure of a plurality of at least three superimposed subcomposites comprising the steps of:
providing a plurality of organic dielectric subeomposite structures, each having openings therein and a plurality of through via openings therein extending between said faces, and wherein the via openings in each subcomposite structure are positioned to align with an opening in at least one opening in a subcomposite structure that is to be adjacent said each subcomposite structure, and printed wiring on at least one face of one subcomposite structure,
filling each via opening with a conductive paste material that can be hardened or cured with said conductive paste material extending beyond at least one face of the subcomposite structure,
providing a plurality of aligned index openings, each subcomposite structure which will cooperate with a fixture to align at least some of said via holes in adjacent components when in superimposed relationship,
providing adhesive for location between adjacent superimposed structures, said adhesive having openings for said conductive paste,
laying up said subcomposite with said adhesive material disposed there between in superposed relationship on a fixture, including elements extending through said index openings to align said subcomposite structures with conductive paste in adjacent openings in said subcomposite structures, in contact with each other; and
fully curing said conductive paste in said adjacent subcomposite structure to form a laminated composite structure.

2. The invention as defined in claim 1 wherein said adhesive material is in the form of separate adhesive sheets.

3. The invention as defined in claim 1 wherein said via openings have plated conductive surfaces.

4. The invention as defined in claim 1 wherein said via openings are free of plating therein.

5. The invention as defined in claim 3 wherein at least some of said vias are copper plated.

6. The invention as defined in claim 1 wherein said conductive paste is partially cured or dried before the subcomposites are laminated.

7. The invention as defined in claim 1 wherein said vias are filled with said conductive paste through a mask.

8. The invention as defined in claim 7 wherein each of said subcomposites are registered with said registration openings and said mask to fill the openings with the conductive paste.

9. The invention as defined in claim 7 wherein circuitry is applied to at least one side of at least one of said subcomposite through said mask.
